(19) United States
(12) Patent Application Publication
(10) Pub. No.: US 2013/0022770 A1
(43) Pub. Date: Jan. 24, 2013

(54) DIACYLOXYSILANE-BASED, MOISTURE-CROSSLINKABLE ETHENE POLYMERS

(71) Applicant: Juergen Oliver Daiss, Munich (DE)

(72) Inventor: Juergen Oliver Daiss, Munich (DE)

(73) Assignee: WACKER CHEMIE AG, Munich (DE)

(21) Appl. No.: 13/638,905

(22) PCT Filed: Mar. 23, 2011
(86) PCT No.: PCT/EP2011/054413

§ 371 Date: Oct. 1, 2012

(30) Foreign Application Priority Data
Apr. 1, 2010 (DE) 102010003588.2

(51) Int. Cl. C08F 255/02; B32B 1/08; B32B 5/02; C07F 7/08

(52) U.S. Cl. 428/36.9; 525/288; 521/143; 556/442; 428/221

(57) ABSTRACT

Polyethylene homo or copolymers which further contain grafted or copolymerized vinyldiacyloxysilanes are easily processable without premature crosslinking, are easily formed into shaped articles by conventional processing methods, and yet rapidly crosslink to form crosslinked polymers.

### CROSS-REFERENCE TO RELATED APPLICATIONS

This application is the U.S. national phase of PCT Application No. PCT/EP2011/054413 filed Mar. 23, 2011 which claims priority to German application No. 2010 003 588.2 filed Apr. 1, 2010, the disclosures of which are incorporated in their entirety by reference herein.

### BACKGROUND OF THE INVENTION

1. Field of the Invention

The present invention relates to moisture-crosslinkable polymers which contain units derived from ethylene and vinylmethyldiacyloxysilane, especially vinylmethyldiacyloxysilanes, to methods of producing the moisture-crosslinkable polymers, to methods of crosslinking the moisture-crosslinkable polymers with water to form crosslinked polymers, to the crosslinked polymers themselves, and to the use of the moisture-crosslinkable polymers and crosslinked polymers.

2. Detailed Description of the Related Art

The crosslinking characteristics of moisture-crosslinkable polymers are decisive for their practical use. The main requirements are:
1. manageability of the polymer, (e.g. in processes such as production, processing, and forming;
2. prompt moisture-crosslinking, as soon as this is desired, and as simply as possible without special moistening and/or heating;
3. good resistance of the crosslinked polymer, e.g. with regard to properties such as mechanical, chemical, thermal, and aging resistance; and
4. non-criticality of the composition with respect to toxicity, recycling, and non-critical combustion residues.

For polymers derived from ethylene such as polyethylene homopolymers and ethylene copolymers, some of these requirements are fulfilled by modification with alkoxysilanes, for example vinyltrimethoxysilane or vinyltriethoxysilane. These silanes can undergo radical copolymerization with ethylene and optionally other monomers, or they can be grafted onto the polymers by a free radical process. Under these conditions, polyolefins from olefins with three or more carbon atoms, for example polymers derived from propene or 1-butene display a tendency to cleavage, by the so-called “visbreaking reaction”, so that free radical-induced silane functionalization of olefin polymers or olefin copolymers not derived from ethylene, produce low-molecular products with low mechanical strength, rather than the desired products.

Alkoxysilane-functionalized polymers derived from ethylene in particular, provided that no crosslinking catalysts have been incorporated, exhibit good manageability (requirement #1 is fulfilled) and commercially available products exhibit very good mechanical, chemical, thermal and aging resistance properties (requirement #3 is fulfilled). In order to achieve a usable rate of moisture-crosslinking, an alkoxysilane-based polyethylene or ethylene copolymer must, however, be mixed with a catalyst, the most efficient catalysts being compounds of tin. As tin has element-specific toxicity, requirement #4 is not fulfilled by these materials. Even in the presence of catalysts, rapid crosslinking of alkoxysilane-based polymers cannot be achieved without heating and special moistening (requirement #2 is not fulfilled).

One possibility for producing moisture-crosslinkable polymers derived from ethylene with increased moisture-crosslinking reactivity is the functionalization of polyethylene or of ethylene copolymers with silanes which are more reactive to moisture and condense to siloxanes more quickly than alkoxysilanes. Acyloxysilanes possess this increased reactivity. Under the action of moisture, the Si-bonded acyloxy group (structural characteristic: ***Si—O—C(═O)*; *=further valences) of the acyloxysilanes hydrolyzes to a silanol group and one equivalent of carboxylic acid. The silanol then condenses with another equivalent of silanol with elimination of water or with another equivalent of acyloxysilane with cleavage of carboxylic acid, to produce a siloxane.

This reaction can be utilized for moisture-crosslinking of polymers when the siloxane-producing acyloxysilane groups are attached to polymers. The crosslinking reaction of the acyloxysilanes is so rapid that it takes place at room temperature even without added catalysts, and under atmospheric conditions, and so without special moistening. The carboxylic acids that are eliminated may have autocatalytic action. Accordingly, copolymers of vinyltriacetoxysilane with polymers derived from ethylene and the rapid crosslinking thereof have already been described in the literature (see the documents CN 1 470 540 A, JP 10 036 617 A, JP 04 041 540 A, JP 60 170 672 A and EP 160 636 A2 and Japanese Journal of Applied Physics, Part 1: Regular Papers, Short Notes & Review Papers, 1991, Vol. 30, No. 4, p. 720-726). However, the crosslinking of the ethylene polymers or copolymers that are derived from vinyltriacyloxysilanes is so rapid that they are not manageable in industrial production processes (requirement #1 is not fulfilled).

For copolymers of various (vinyl)(acyloxy)silanes, which in contrast have no units derived from ethylene as monomer, the resultant polymers were described as viscous or as oils (see EP 148 398 A2), and they thus have no notable mechanical resistance (requirement #3 is not fulfilled by these polymers).

The problem to be solved by the invention is to provide ethylene-derived, moisture-crosslinkable polymers that fulfill the aforementioned main requirements 1-4.

### SUMMARY OF THE INVENTION

The invention thus relates to polymers (P), which contain units that are derived from the monomers ethylene and vinylmethyldiacyloxysilanes of general formula I

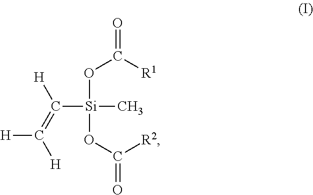

wherein the residues R¹ and R² are selected from hydrogen atoms and hydrocarbon residues.

### DETAILED DESCRIPTION OF THE PREFERRED EMBODIMENTS

The polymers (P) can be produced by copolymerization of mixtures containing ethylene and silane of general formula I or by grafting of polymers containing units that are derived from ethylene with a silane of general formula I.

It was found that the polymers (P) that contain units that are derived from ethylene and vinylmethyldiacyloxysilane of general formula I are manageable during production and forming (requirement #1 is fulfilled), are fully crosslinked very quickly even at room temperature under atmospheric conditions (requirement #2 is fulfilled), display good resistance (requirement #3 is fulfilled) and, as crosslinking takes place without catalysts, do not require any problematic additives (requirement #4 is fulfilled).

It was found, surprisingly, that polymers not according to the invention, whose units are derived from vinyltriacyloxysilanes and ethylene as monomers, already undergo purely thermal crosslinking in the conditions of production and processing, in that two Si-bonded acyloxy equivalents form the corresponding carboxylic acid anhydride and one siloxane equivalent, so that these polymers already undergo precrosslinking during production and processing, even if no catalysts are added and moisture is carefully excluded. Control of crosslinking by controlling the amount and point in time of water access therefore is not possible for these polymers, and thus controlled processing and forming is also not possible. In contrast, it was found that polymers (P) according to the invention can accept far greater thermal loading and therefore can be robustly produced and processed, and afterwards can be crosslinked quickly by the action of moisture. Optionally, during production and processing of polymers (P), it is possible to control partial crosslinking by controlling water access, even deep into manufactured formed articles, provided this does not adversely affect the processing, in order to shorten the subsequent crosslinking time.

R¹ and R² can for example be cyclic, oligocyclic, polycyclic or acyclic or can have cyclic, oligocyclic, polycyclic or acyclic groups; can be linear or branched; can have heteroatoms; can be bound together intramolecularly, so that rings form; can be bound together so that chains form; can be bound to one another inter- and intramolecularly, so that oligomeric rings form; can be saturated or aromatically or olefinically or acetylenically unsaturated.

Preferably R¹ or R² cue hydrogen or a C₁-C₄₀ hydrocarbon residue, preferably hydrogen or a C₁-C₃₀ hydrocarbon residue, most preferably a C₁-C₃₀ hydrocarbon residue. Preferably R¹ or R² is saturated or has aromatic unsaturation, more preferably saturated. Preferably R¹ or R² has no olefinic or acetylenic unsaturation. Preferably R¹ or R² is acyclic, preferably linear, and bound via a terminal carbon atom to the carbonyl group.

Preferably the residues R¹ or R² are selected from hydrogen, methyl, ethyl, n-propyl, iso-propyl, n-butyl, sec-butyl, isobutyl, tert-butyl, n-pentyl, n-hexyl, n-heptyl, (1-ethylpentyl), n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, phenyl, 2-methylphenyl, 3-methylphenyl, 4-methylphenyl, benzyl, 2-naphthyl, or 3-naphthyl; from saturated, partially hydrogenated or fully hydrogenated residues of acids that can be produced by the Koch reaction from alkenes or multiply olefinically unsaturated compounds; the neononyl residues of neodecanoic acid (neodecanoic acid, or “neononyl”-COOH, available from ExxonMobil), the versatyl residues of the versatates (“versatic acid-9” or “versatic acid-10”, or “versatyl”-COOH, available from Hexion), or the unhydrogenated, partially hydrogenated or fully hydrogenated organic residues of the resin acids, for example the unhydrogenated, partially hydrogenated or fully hydrogenated organic “abietyl” residue of abietic acid (“abietyl”-COOH); preferably from hydrogen, methyl, ethyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, phenyl, 2-methylphenyl, 3-methylphenyl, and 4-methylphenyl most preferably R¹ and R² are methyl residues, which means that the especially preferred silane of general formula I is vinylmethyldiacetoxysilane.

In addition to units derived from the monomers silane of general formula I and ethylene, polymers (P) can optionally also have units that are derived from other monomers, for example from olefins such as propene, but-1-ene, 2-methylpropene, pent-1-ene, hex-1-ene, 4-methylpent-1-ene, styrene, buta-1,3-diene, isoprene, or from vinyl esters such as vinyl acetate, vinyl butyrate, vinyl pivalate, vinyl laurate, or from acrylic or methacrylic acid or esters thereof such as methyl, ethyl or butyl acrylate or methacrylate, or from other monomers such as acrylonitrile, vinyl chloride, acrylamide, or N-vinylpyrrolidone, or from other silanes that do not correspond to general formula I, for example alkoxysilanes copolymerizable with ethylene such as vinyltrimethoxysilane, vinylmethyldimethoxysilane, vinyltriethoxysilane, vinylmethyldiethoxysilane, (methacryloyloxymethyl)trimethoxysilane, (methacryloyloxymethyl)(methyl)-dimethoxysilane, (methacryloyloxymethyl)triethoxysilane, (methacryloyloxymethyl)(methyl)diethoxysilane, (methacryloyloxypropyl)trimethoxysilane, (methacryloyloxypropyl)(methyl)dimethoxysilane, (methacryloyloxypropyl)triethoxysilane, (methacryloyloxypropyl)(methyl)diethoxysilane, or the corresponding silanes, in which the methoxy groups have partially been exchanged for ethoxy groups.

The polymers (P) have on average preferably at least 1, more preferably at least 1.01, most preferably at least 1.5 and preferably at most 20, more preferably at most 10, and most preferably at most 5 silane groups of the general formula —Si(OC(O)R¹)(OC(O)R²)(Me) per polymer molecule. If for example the polymers (P) are in the form of a mixture of polymer molecules bearing silane groups with this structure, with other polymer molecules not bearing silane groups with this structure, the overall mixture can, statistically on average over all polymer molecules, also have for example at least 0.001, preferably at least 0.01, more preferably at least 0.1, and most preferably at least 0.2 and for example at most 100, preferably at most 20, more preferably at most 10, and most preferably at most 5 of these silane groups per polymer molecule.

The polymers (P) can also bear other groups, for example other silane groups that do not correspond to the formula —Si(OC(O)R¹)(OC(O)R²)(Me), or can be in a mixture with other polymers that bear other groups or other silane groups than those corresponding to the formula —Si(OC(O)R¹)(OC(O)R²)(Me); the total number of all silane groups per polymer molecule is then on average for example at least 0.1, preferably at least 1, more preferably at least 1.01, and most preferably at least 1.5 and preferably at most 40, more preferably at most 20, and most preferably at most 10. The basis for calculation of the average number of silane groups per polymer molecule is the number-average molecular weight Mn of the polymer (P).

Silanes of general formula I can for example be produced by a method in which vinylmethyldihalosilanes are reacted with carboxylic acids of the formulas R¹C(O)OH and R²C(O)OH or with their salts or with their symmetric or asymmetric carboxylic acid anhydrides or with mixtures of the acids, salts and anhydrides, optionally with further additives such as solvents, auxiliary bases or catalysts, wherein as a rule the corresponding hydrogen halides and, if carboxylic acids were used, or the corresponding halide salts, if carboxylic acid salts were used, or the corresponding acyl halides, if carboxylic acid anhydrides or carboxylic acids were used, are eliminated. Corresponding synthesis conditions are given for example in Journal of the American Chemical Society, 1952, Vol. 74, p. 4584-4585 or in the patent applications JP 55 154 983 A2 and US 2004/0228902 A1.

In the moisture-crosslinking of the polymers (P), the carboxylic acids R¹—C(O)OH or R²—C(O)OH are formed as cleavage products. Cleavage products that have low vapor pressures are advantageous, so that pollution of the environment by these substances via the gas phase during crosslinking is reduced or prevented. If R¹ and R² stand for alkyl residues, the vapor pressure of the carboxylic acid cleavage products decreases with increasing chain length of R¹ or R², and for this in each case at least 4 carbon atoms in R¹ or R² are advantageous.

Polymers (P) whose silane groups have residues R¹ or R² with at least 4 carbon atoms are designated hereinafter as polymers (P1). They can be produced by using at least one vinylmethyldiacyloxysilane of general formula II,

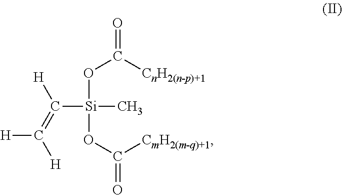

wherein m and n are selected independently of one another from integral values greater than or equal to 4 and

p is selected from integral values from 0 to n and

q is selected from integral values from 0 to m.

The silanes of general formula II are preferred silanes of general formula I.

For example n and m can take integral values from 4 to 40. Preferably n and m are selected from integral values from 9 to 40, preferably from 11 to 40, more preferably from 13 to 40, and in particular from 13 to 30. Examples of n and m are 4, 5, 6, 7, 8, 9, 10, 11, 12, 13, 14, 15, 16, 17, 18, 19, 20, 21, 22, 23, 24, 25, 26, 27, 28, 29 and 30.

Vinylmethyldiacyloxysilanes of general formula II, for which m and n are selected independently of one another from integral values from 13 to 40,

p is selected from integral values from 0 to n and

q is selected from integral values from 0 to m,

are also covered by the invention. They are most preferably used for producing the polymers (P1).

Vinylmethyldiacyloxysilanes whose residues CₙH₂₍ₙ₋ₚ₎₊₁ and CₘH_{2(m-q)+1} are acyclic, have, as such and as a unit in polymers derived from them as monomer, advantageous solubility properties and phase compatibility, especially when the residues CₙH₂₍ₙ₋ₚ₎₊₁ and CₘH_{2(m-q)+1} are linear, in particular when they are bound via a terminal carbon atom to the carbonyl group.

Vinylmethyldiacyloxysilanes of general formula II, for which m and n are selected independently of one another from integral values from 4 to 40, preferably from 5 to 35, more preferably from 6 to 30, and most preferably from 7 to 30,

p is selected from integral values from 0 to n,

q is selected from integral values from 0 to m,

and the residues CₙH₂₍ₙ₋ₚ₎₊₁ and CₘH_{2(m-q)+1} are acyclic hydrocarbon residues, which are preferably linear or branched, more preferably linear and most preferably are bound at a terminal carbon atom to the carbonyl group, are also covered by the invention.

They are also most preferably used for producing the polymers (P1).

An example of a linear hydrocarbon residue is a heptyl residue (C₇H₁₅), which for example can be bound via a terminal carbon atom or via the second, third or fourth carbon atom of the carbon chain to the carbonyl group. That the residues CₙH₂₍ₙ₋ₚ₎₊₁ and CₘH_{2(m-q)+1} are acyclic hydrocarbon residues means that they are neither completely cyclic, nor do they have cyclic groups.

Preferably p is selected from integral values from 0 to (n−1), more preferably from 0 to (n−2), and most preferably from 0 to (n−3).

Preferably q is selected from integral values from 0 to (m−1), more preferably from 0 to (m−2), and most preferably from 0 to (m−3).

Preferably p and q are selected from 0, 1 or 2, more preferably from 0 or 1, and most preferably p and q take the value 0. Examples of p and q are 0, 1, 2, 3, 4, 5, 6 and 7.

The invention further relates to a method of producing polymers (P) by radical grafting, in which a mixture containing

(A) a polymer (PE), which contains units that are derived from the monomer ethylene (grafting base),

(B) a silane of general formula I, and

(C) a radical initiator, which releases radicals under the selected reaction conditions of grafting, are reacted.

The polymer (PE) used as the grafting base is preferably produced from more than 50%, more preferably more than 70%, and most preferably more than 90% ethylene monomer. In particular, polymer (PE) can be produced exclusively from commercially available ethylene grades, exclusively from commercial, pure or high-purity ethylene, or exclusively from ethylene as a monomer. In addition to units derived from ethylene, the polymers (PE) can optionally contain units that are derived from other monomers, for example from olefins such as propene, but-1-ene, 2-methylpropene, pent-1-ene, hex-1-ene, 4-methylpent-1-ene, styrene, buta-1,3-diene, isoprene, or from vinyl esters such as vinyl acetate, vinyl butyrate, vinyl pivalate, vinyl laurate, or from acrylic or methacrylic acid or esters thereof such as methyl, ethyl or butyl acrylate or methacrylate, or from other monomers such as acrylonitrile, vinyl chloride, acrylamide, or N-vinylpyrrolidone, or from other silanes that do not correspond to formula I, for example alkoxysilanes copolymerizable with ethylene such as vinyltrimethoxysilane, vinylmethyldimethoxysilane, vinyltriethoxysilane, vinylmethyldiethoxysilane, (methacryloyloxymethyl)trimethoxysilane, (methacryloyloxymethyl)(methyl)dimethoxysilane, (methacryloyloxymethyl)triethoxysilane, (methacryloyloxymethyl)(methyl)diethoxysilane, (methacryloyloxypropyl)trimethoxysilane, (methacryloyloxypropyl)(methyl)dimethoxysilane, (methacryloyloxypropyl)triethoxysilane, (methacryloyloxypropyl)(methyl)diethoxysilane, or the corresponding silanes, in which the methoxy groups have partially been exchanged for ethoxy groups.

Before, during or after carrying out the grafting process with the silane of general formula I, the polymer (P) can be modified by grafting with other olefinically unsaturated compounds or with other silanes bearing olefinically unsaturated groups.

Preferably at least 0.1, more preferably at least 0.3, and most preferably at least 0.5 parts by weight, and preferably at most 40, more preferably at most 30, and most preferably at most 20 parts by weight of component (B) are used, relative to 100 parts by weight of component (A).

Preferably at least 0.01, more preferably at least 0.02, and most preferably at least 0.03 parts by weight, and preferably at most 5, more preferably at most 1, and most preferably at most 0.3 parts by weight of component (C) are used, relative to 100 parts by weight of component (A).

Optionally, in the grafting process, independently of one another, several polymers (PE), several silanes of general formula I or several radical initiators can be used, or they can be used as constituent(s) of mixtures with other components. For example, other polymers can also be added that do not correspond to the definition of (PE), or for example other saturated or unsaturated compounds or other silanes that do not correspond to general formula I can be added. As further unsaturated compounds that can be added in the grafting process, it is possible for example to use those monomers from which the polymer (PE) can have derived units as described hereunder.

If several unsaturated compounds are present during grafting, the grafting can take place in the sense of graft copolymerization or by separate grafting of the unsaturated compounds or grafting of only a proportion of the unsaturated compounds. Other silanes can be used, in addition to silanes of general formula I. These can have saturated or unsaturated groups. They can have hydrolyzable or nonhydrolyzable groups, or both. Preferably the silanes of general formula I account for at least 5%, more preferably at least 10%, yet more preferably at least 20%, and most preferably at least 50%, relative to the sum total of the silanes used. All the silanes used can also be selected exclusively from silanes of general formula I. Preferably a polymer (PE), an unsaturated compound that is a silane of general formula I, and a radical initiator are used.

Preferably the molar ratio of all the unsaturated monomeric compounds used during grafting to all the initiators used is at least 3:1, more preferably at least 4:1, and most preferably at least 5:1 and preferably at most 2000:1, more preferably at most 1000:1, and most preferably at most 400:1. Preferably the unsaturated monomeric compounds used are silanes.

Grafting is preferably carried out at temperatures of at least 60° C., more preferably at least 90° C., and most preferably at least 120° C., and preferably at most 400° C., more preferably at most 350° C., and most preferably at most 300° C. The temperature can be varied during grafting or can be controlled as a gradient. For temperature adjustment, thermal energy can be supplied for example by shearing or can be supplied or abstracted using a heating or cooling jacket (for example with steam, superheated steam, oil, brine, water or electrically).

Grafting can be carried out at atmospheric pressure, increased pressure, in vacuum or in partial vacuum. The process can be carried out over a wide pressure range, for example at least 1 Pa, preferably at least 100 Pa, more preferably at least 10 kPa, and most preferably at least 50 kPa, and for example at most 100 MPa, preferably at most 50 MPa, more preferably at most 20 MPa, and most preferably at most 10 MPa absolute. In a first especially preferred embodiment, the process is carried out at atmospheric pressure, which depending on ambient conditions is as a rule in a range between 90 and 105 kPa absolute. In a second especially preferred embodiment the process is carried out at a pressure moderately above atmospheric pressure, i.e. at a pressure between atmospheric pressure (depending on ambient conditions, as a rule between 90 kPa and 105 kPa absolute) and 1 MPa, in particular between atmospheric pressure and 500 kPa. If grafting is carried out in a continuous process, for example in reactive extrusion, in a delay tube or in a mixer, the pressure can be controlled via parameters such as throughput, tube, mixer or feed screw configurations. The pressure can be varied during grafting or can be controlled as a gradient.

Dialkyl peroxides, for example, may be used as radical initiators in the process, for example di-tert-butyl peroxide, 2,5-dimethyl-2,5-di-(tert-butylperoxy)hexane, dicumyl peroxide, tert-butyl-α-cumyl peroxide, α,α′-bis(tert-butylperoxy)diisopropylbenzene, di-tert-amyl peroxide, and 2,5-dimethyl-2,5-di-(tert-butylperoxy)hex-3-ine; diacyl peroxides such as dibenzoyl peroxide, dilauroyl peroxide, didecanoyl peroxide, or diisononaoyl peroxide; alkyl peresters such as 3-hydroxy-1,1-dimethylbutyl-peroxyneodecanoate, α-cumylperoxyneodecanoate, 2-hydroxy-1,1-dimethylbutylperoxyneoheptanoate, α-cumylperoxyneoheptanoate, tert-amylperoxyneodecanoate, tert-butylperoxyneodecanoate, tert-butylperoxyneoheptanoate, tert-amylperoxypivalate, tert-butylperoxypivalate, 3-hydroxy-1,1-dimethylbutylperoxy-2-ethylhexanoate, 2,5-dimethyl-2,5-di(2-ethylhexanoylperoxy)hexane, tert-amylperoxy-2-ethylhexanoate, tert-butylperoxy-2-ethylhexanoate, tert-butylperoxyisobutyrate, 2,5-dimethyl-2,5-di(benzoylperoxy)hexane, tert-amylperoxyacetate, tert-amylperoxybenzoate, tert-butylperoxyisononanoate, tert-butylperoxyacetate, tert-butylperoxybenzoate, di(tert-butylperoxy)phthalate, and tert-butylperoxy-2-ethylhexanoate; perketals such as 1,1-di(tert-butylperoxy)-3,3,5-trimethylcyclohexane, 1,1-di(tert-butylperoxy)cyclohexane, 1,1-di-(tert-amylperoxy)cyclohexane, 2,2-di-(tert-butylperoxy)butane, 2,2-di-(tert-amylperoxy)propane, n-butyl-4,4-di-(tert-butyl)peroxyvalerate, ethyl-3,3-di-(tert-amylperoxy)butyrate, and ethyl-3,3-di-(tert-butylperoxy)butyrate; cyclic peroxides such as 3,6,9-triethyl-3,6,9-trimethyl-1,1,4,4,7,7-hexaoxacyclononane; azo compounds such as α,α′-azobisisobutyronitrile; or C-radical formers such as 3,4-dimethyl-3,4-diphenylhexane, 1,2-diphenylethane or 2,3-dimethyl-2,3-diphenylbutane; peroxycarbonates or dicarbonates such as di(2-ethylhexyl)peroxydicarbonate, di-n-propylperoxydicarbonate, di-sec-butyl-peroxydicarbonate; photoinitiators such as 2-hydroxy-2-methyl-1-phenyl-1-propanone; or chlorine, bromine or iodine in combination with the action of electromagnetic radiation. Further examples of chemical radical initiators that can be used are described for example in D. Munteanu, in Plastics Additives Handbook, 5th Edition, Hanser-Verlag, Munich 2001, p. 741-742, or in the brochure “Initiators for high polymers” of the company Akzo Nobel (Issue: June 2006; Code: 2161 BTB Communication, © 2006 Akzo Nobel Polymer Chemicals, see http://www.akzonobel-polymerchemicals.com/NR/rdonlyres/C2D64A96-B539-4769-A688-2447258D3DCA/0/Initiatorsfor HighPolymersAkzoNobe12006.pdf). Moreover, the radical initiator can be introduced into the reaction as a constituent of the polymer to be grafted (PE). For this, the polymer to be grafted (PE) can, for example in the presence of oxygen (O₂), be exposed for example to electromagnetic radiation, such as light, ultraviolet radiation or gamma-radiation. There is formation of for example polymer-bound hydroperoxide groups, which, when the polymer is used later in the grafting process, can act as radical initiators. Furthermore, another polymer, which does not correspond to the definition of (PE), but has peroxide or hydroperoxide groups, can be used as radical initiator.

Initiator half-lives for different temperatures are given in the literature or can be calculated from values given in the literature for the decomposition rates, see for example the literature cited above in this section or Polymer Handbook, Fourth Edition, Volume 1, J. Brandrup, E. H. Immergut, E. A. Grulke (Eds.), Wiley-Interscience, John Wiley & Sons, Hoboken, N.J., p. II/1-II/76; knowing the activation energy and the Arrhenius constant of initiator decomposition, it is possible to calculate the half-lives at different temperatures (for data and calculation see the cited literature or http://www.arkema-inc.com/index.cfm?pag=353, see the document downloadable there “Half life selection guide”).

Grafting can for example be carried out in the solid, for example by allowing the radical initiator and the silane to diffuse into a polymer (PE) and then heating the mixture to a temperature below the melting point of the mixture. Grafting can also be carried out in the melt, for example by incorporating the radical initiator and the silane in a polymer (PE) in the solid or liquid state, melting if it has not melted already, and heating the melt. Grafting can be carried out for example in solution, suspension, emulsion or in the bulk, in the subcritical or supercritical state.

Grafting can be carried out for example as a batch process (for example in tank reactors, preferably stirred), or for example continuously (for example in extruders, in dynamic mixers or in static mixers, optionally with one or more downstream, optionally temperature-controlled delay vessels or delay tubes), or for example in cascade reactions. If the method is carried out in batch reactions, then preferably one batch after another is carried out in the batch reactor, if possible without thorough cleaning of the reactor between discharge and the next batch.

In batch grafting, a mixture containing at least one polymer (PE), at least one radical initiator and at least one silane of general formula I is heated to a temperature at which the radical initiator forms radicals, for a time of preferably 2-100 half-lives of the radical initiator used at the selected temperature, more preferably 2-50 half-lives, and most preferably 4-25 half-lives. The silane and the initiator can be dosed as a mixture or separately from one another, in each case in one addition or in several additions. Solvents can be added or removed again, for example by distillation, at any point in time. Preferably, in the case of batch grafting, the combination of temperature during grafting and the initiator is selected in such a way that the initiator has a half-life of at least 1 second, preferably at least 10 seconds, most preferably at least 30 seconds, and preferably at most one hour, more preferably at most 20 minutes, and most preferably at most 10 minutes.

For grafting in the extruder, at least one silane of general formula I and at least one radical initiator are added in at least one suitably temperature-controlled point of the extruder to the polymer (PE) or to a mixture that contains at least one polymer (PE). “Suitably temperature-controlled” means that the dosing point is adjusted to a temperature such that the temperature is low enough to avoid dangerous decomposition of the added chemicals and of the polymer (PE), but at the same time is high enough for processing the polymer in the extruder (the corresponding upper and lower temperature limits can easily be determined by a person skilled in the art from data for the temperature dependence of in particular the half-life of the selected radical initiator and from the material data of the polymer (PE) used relating to viscosity and melting point; these data can as a rule be obtained from the respective manufacturers). The silane and the radical initiator can be added separately from one another or as a mixture of the two, and in both cases other additives can be incorporated. If a mixture is added, the maximum temperature at the dosing point is preferably assigned according to the decomposition temperature of the mixture. The addition is preferably controlled in such a way that when the silane comes in contact with the polymer (PE), the radical initiator has not yet, or not yet completely, reacted. Optionally, further radical initiator and/or further silane can be added at other points of the extruder, optionally repeatedly, for example at the feed point of the extruder or along the extrusion section. For reactive extrusion, it is possible for example to use a single-screw extruder or a co-rotating or counter-rotating twin-screw extruder, preferably a single-screw extruder or a co-rotating twin-screw extruder.

In a preferred embodiment of grafting in at least one dynamic or static mixer, a polymer (PE) is fed as a melt into a dynamic or static mixer; for this, it is possible for example to use an extruder, preferably a single-screw extruder or a counter-rotating twin-screw extruder or a co-rotating single-screw extruder with screws of different lengths. Then the silane of general formula I and the radical initiator, separately from one another or as a mixture, are fed into the mixer or the extruder or the transition between the two. The additions of silane and radical initiator can be made as a mixture or individually in each case at one point or distributed over several points, optionally repeatedly, for example at the feed section of the extruder, along the extrusion section, between extruder and mixer or into the mixer. Silane and/or radical initiator can also be added as a mixture with polymer (PE) or with other polymers. Several mixers, delay vessels or tubes can be connected in parallel or in series.

The combination of extruder design, with or without downstream mixer, temperature-controlled delay vessel or delay tube, initiator, selected degree of filling and throughput and residence time defined thereby is preferably arranged so that the mixture is held in the temperature-controlled reaction zone for a time of 1-30 half-lives of the radical initiator used, preferably 2-20 half-lives, and most preferably 3-10 half-lives. Temperature control is preferably by jacket heating or with thermal insulation. Preferably the initiator is added at a point that is adjusted to a temperature such that the half-life of the initiator at the temperature at this point is at least 1 second, preferably at least 20 seconds, and most preferably at least 60 seconds.

Preferably the temperature profile of the equipment is selected in such a way that the temperature after the initiator dosing zone, in at least one region following the dosing zone, is equal to or higher, preferably higher, than in the dosing zone of the initiator itself. The average residence time in the temperature-controlled reaction zone of the reaction mixture, containing silane, radical initiator and polymer, is preferably at least 0.1, more preferably at least 0.25, and most preferably at least 0.5 minutes and preferably at most 20 minutes, more preferably at most 10 minutes, and most preferably at most 5 minutes, and the average residence time in the complete system from material feed or dosing to the discharge end is at least or at most preferably, more preferably and most preferably in each case twice as long. The residence time as well as the residence time distribution can be varied for example by means of the length of the extruder, the rotary speed, the screw pitch, the degree of filling or by using backflow elements or die restrictions and via the volume of optional delay tubes or delay vessels or mixers installed downstream. The residence time and the residence time distribution can be found for example by adding a coloring agent, for example graphite, in the feed section of the extruder or at relevant dosing points, and determining the time for the coloration to appear at the discharge end.

Preferably, in the continuous forms of radical grafting, the combination of initiator and temperature in the reaction zone for grafting is selected in such a way that the initiator in the reaction zone has a half-life of preferably at least 0.1 seconds, more preferably at least 0.5 seconds, most preferably at least 2 seconds, and preferably of at most 10 minutes, more preferably at most 4 minutes, and most preferably at most 2 minutes.

The invention further relates to a method of producing the polymers (P) by radical copolymerization, in which a mixture containing

(D) ethylene,

(E) a silane of general formula I, and

(F) a radical initiator, which releases radicals in the selected reaction conditions of copolymerization, is reacted.

Preferably at least 0.1, more preferably at least 0.3, most preferably at least 0.5 parts by weight, and preferably at most 40, more preferably at most 30, and most preferably at most 20 parts by weight of component (E) are used relative to 100 parts by weight of component (D).

Preferably at least 0.01, more preferably at least 0.02, most preferably at least 0.03 parts by weight, and preferably at most 5, more preferably at most 1, and most preferably at most 0.3 parts by weight of component (F) are used relative to 100 parts by weight of component (D).

Optionally, in the copolymerization process, further olefinically unsaturated compounds other than ethylene, several silanes of general formula I or other additional silanes, or several radical initiators can be used independently of one another, or they can be used as constituent(s) of mixtures with other components.

The copolymerization can lead for example to a statistical distribution of the units in the polymer derived from the (polymerized) monomers, to block copolymerization or to alternating polymerization. Further silanes can be used, in addition to silanes of general formula I. These can have saturated or unsaturated groups. They can have hydrolyzable or nonhydrolyzable groups, or both. Preferably the silanes of general formula I make up at least 5%, more preferably at least 10%, yet more preferably at least 20%, and in particular at least 50%, relative to the sum total of the silanes used. All silanes used can also be selected exclusively from silanes of general formula I. Preferably ethylene, an unsaturated compound that is a silane of general formula I, and a radical initiator are used.

Preferably, in copolymerization, the molar ratio of all the unsaturated monomeric compounds used to all the initiators used is at least 10:1, more preferably at least 50:1, most preferably at least 100:1 and preferably at most 1,000,000:1, more preferably at most 100,000:1, and most preferably at most 10,000:1. Preferably the unsaturated monomeric compounds used are silanes, and olefins that consist exclusively of carbon and hydrogen, in particular ethylene.

As radical initiators in the copolymerization process, it is possible for example to use the same initiators as are described above for radical grafting, with the difference, with regard to the polymer-bound initiators described there, that in the copolymerization process these are not usually regarded as a grafting base. Moreover, the copolymerization can be initiated by the presence of oxygen, which, optionally in a preceding step, for example in the presence of ethylene, can form ethylene hydroperoxide, which can act as initiator. The combination of temperature during copolymerization and initiator is preferably selected in such a way that the initiator has a half-life of preferably at least 0.01 seconds, more preferably at least 0.1 seconds, and most preferably at least 1 second, and preferably at most 10 hours, more preferably at most 1 hour, and most preferably at most ¼ hour.

Copolymerization can be carried out for example at temperatures from 50° C. to 400° C. and at pressures from 5 MPa to 600 MPa absolute. Radical copolymerization is preferably carried out at temperatures of at least 120° C., more preferably at least 150° C., and most preferably at least 180° C., and preferably at most 360° C., more preferably at most 340° C., and most preferably at most 320° C. Radical copolymerization is preferably carried out at more than 10 MPa absolute, more preferably at more than 25 MPa, most preferably at more than 40 MPa, and preferably at most at 550 MPa absolute, more preferably at most at 500 MPa, and most preferably at most at 450 MPa. The pressure and/or the temperature can be varied during the copolymerization or controlled as a gradient.

During copolymerization, optionally regulators can be added, for example saturated or unsaturated hydrocarbons, alcohols, ketones, chlorohydrocarbons, thio compounds, thiols or aldehydes. A regulator can for example influence the molecular weight distribution of the product.

In copolymerization, in addition to ethylene and silane of general formula I, optionally further comonomers can be added and copolymerized, for example olefins such as propene, but-1-ene, 2-methylpropene, pent-1-ene, hex-1-ene, 4-methylpent-1-ene, styrene, buta-1,3-diene, isoprene, or vinyl esters such as vinyl acetate, vinyl butyrate, vinyl pivalate, vinyl laurate, or acrylic or methacrylic acid or esters thereof such as methyl, ethyl or butyl acrylate or methacrylate, or other monomers such as acrylonitrile, vinyl chloride, acrylamide, or N-vinylpyrrolidone, or other silanes that do not correspond to formula I, for example alkoxysilanes copolymerizable with ethylene such as vinyltrimethoxysilane, vinylmethyldimethoxysilane, vinyltriethoxysilane, vinylmethyldiethoxysilane, (methacryloyloxymethyl)trimethoxysilane, (methacryloyloxymethyl)(methyl)dimethoxysilane, (methacryloyloxymethyl)triethoxysilane, (methacryloyloxymethyl)(methyl)diethoxysilane, (methacryloyloxypropyl)trimethoxysilane, (methacryloyloxypropyl)(methyl)dimethoxysilane, (methacryloyloxypropyl)triethoxysilane, (methacryloyloxypropyl)(methyl)diethoxysilane, or the corresponding silanes, in which the methoxy groups have partially been exchanged for ethoxy groups.

Preferably, in the copolymerization process, in addition to the initiator and optionally regulator, a mixture containing at least 50%, more preferably at least 70%, and most preferably at least 90% ethylene and silane of general formula I in total is used. In an especially preferred embodiment, in addition to the initiator and optionally regulator, a mixture consisting of ethylene and silane of general formula I without further comonomers is used.

Radical copolymerization is preferably carried out in the liquid or gas phase, in the subcritical or supercritical state, in the bulk or in solution, or in a multiphase mixture, for example in a smoke, mist, suspension or emulsion or a mixture of several of these multiphase mixtures. Radical copolymerization can be carried out in batch mode, for example in tank reactors or autoclaves, or continuously, for example in tubular reactors.

The polymer (P) can be modified during or after carrying out the copolymerization process by grafting with other olefinically unsaturated compounds or with further silane of general formula I or with other silanes bearing olefinically unsaturated groups.

Both the grafting process and the copolymerization process are preferably carried out under inert conditions. Educts and solvents used preferably contain less than 10,000 ppm water, more preferably less than 1000 ppm, and most preferably less than 200 ppm. Gases used, for example protective gas or ethylene, preferably contain less than 10,000 ppm water, more preferably less than 1000 ppm, most preferably less than 200 ppm, and preferably less than 10,000 ppm oxygen, more preferably less than 1000 ppm, and most preferably less than 200 ppm. Initiators used preferably contain less than 10% water, more preferably less than 1%, and most preferably less than 0.1%.

In the above methods of producing the polymers (P), preferably the silanes of general formula II are used and the polymers (P1) are produced. Another preferred area is the use of vinylmethyldiacetoxysilane for the production of polymers (P).

The polymers (P) or preparations thereof may contain low-molecular compounds, for example unreacted peroxide, decomposition products (hydrolysis and condensation products of the silane or of the polymer (P), peroxide fragments, fragments of the grafting base) or monomers or silane or oligomers thereof used for copolymerization or for grafting. These compounds can optionally remain in the product or can be removed from the polymer (P) or preparations thereof before, during or after adding further ingredients (e.g. adhesive resin, waxes, catalysts), which can take place for example in the case of volatile compounds by applying vacuum, preferably 0.01-500 mbar, more preferably 0.1-300 mbar, and most preferably 0.5-100 mbar, or, for example by baking, preferably at 60-350° C., more preferably at 100-300° C., and most preferably at 150-250° C., or by filtration, for example through a sieve, or by combining several methods, for example application of vacuum and simultaneous baking. The low-molecular weight compounds are preferably removed partially or completely from the polymer (P) or preparations thereof. These processes can be carried out in batch mode or continuously.

Before, during or after production by grafting or before, during or after production by copolymerization, optionally in the same step or in an upstream or downstream process step, the polymers (P) can be mixed with one or more additives, for example with antioxidants, stabilizers, pigments, dyes, processing aids such as oils, silicone oils or waxes, catalysts such as acids, bases or compounds of tin, bismuth, lead, titanium, iron, nickel, cobalt, or fillers such as magnesium oxide, glass fibers, gypsum, lime, clay, optionally hydrated aluminum oxide, silica gel, silica, pyrogenic silicic acid (for example highly-divided pyrogenic silicic acid, HDK® from Wacker Chemie AG). The fillers can optionally be bound to the polymers (P) via the silane groups of the polymers (P), for example when the fillers have hydroxyl or oxide groups on their surface. The polymers (P) can be modified during or after their production with other olefinically unsaturated compounds or with other silanes bearing olefinically unsaturated groups, for example by grafting as described above, or the acyloxy residues of the silane groups that they contain can for example be transformed by reaction with alcohols partially or completely to alkoxy groups or by reaction with carboxylic acids partially or completely to other acyloxy groups. For example, further polymers can also be added, which can have units that are derived from ethylene as monomer, but this is not essential.

The invention also relates to a method of crosslinking the polymers (P) with water. On crosslinking, crosslinked polymer (PX) is obtained. Crosslinked polymers (PX) are also covered by the invention.

The water required for crosslinking can be used as steam and/or liquid water, optionally as solution, suspension, emulsion or mist, or as supercritical water.

The crosslinking can be carried out partially or completely during production of the polymers (P) by grafting or copolymerization, or it can be carried out partially during production and can be continued or completed in a subsequent process step, or it can be carried out completely only after production of the polymers (P). The crosslinking takes place as a rule in a process step following production of the polymers (P) by grafting or copolymerization. The polymer (P) can be as such or it can be in the form of a mixture with additives. Partially or completely water-insoluble additives remain in the polymer partially or completely. Water-soluble additives can, depending on the aging conditions, be dissolved out of the polymer during crosslinking, especially when the water is used in liquid or supercritical form or as solution. Examples of additives are described above. If polymer (P) is used with additives that are not dissolved out completely during crosslinking, polymer (PX) is obtained with undissolved additives.

The crosslinking of the polymers (P) takes place very rapidly in the presence of water even without added catalyst. Crosslinking without added catalyst is especially preferred. The catalysts can, moreover, bring about acceleration of the moisture crosslinking of the polymers (P), by catalyzing the hydrolysis of the hydrolyzable silane groups contained in the polymer (P) under the action of water and/or their condensation to siloxanes. The catalysts can also catalyze a reaction of the hydrolyzable silane groups of the polymers (P) with hydroxyl groups or oxide groups on substrates such as fillers that possess said groups, or on substrate surfaces that possess said groups, such as mineral substances, glass, metals with an oxide layer or wood. The polymer (P) is for example mixed with the catalyst or with a masterbatch of the catalyst, i.e. a mixture of the catalyst with a suitable similar or dissimilar polymer, which preferably contains 100 parts polymer and 0.1-20 parts of the catalyst, preferably in the melt, preferably in an extruder. Preferably the polymer (P) is crosslinked with less than 1%, more preferably less than 0.1%, relative to the finished mixture, and most preferably without added catalyst.

For example organotin compounds, such as dibutyltin dilaurate, dioctyltin dilaurate, dibutyltin oxide, dioctyltin oxide, aza compounds, such as 1,8-diazabicyclo[5.4.0]undec-7-ene, 1,5-diazabicyclo[4.3.0]non-5-ene, 1,4-diaza-bicyclo[2,2,2]octane, bases, for example organic amines, such as triethylamine, tributylamine, ethylenediamine, inorganic or organic acids, such as toluenesulfonic acid, dodecylbenzene-sulfonic acid, stearic acid, palmitic acid or myristic acid can be used as catalysts. Especially preferably the crosslinking of the polymer (P) is carried out without added tin or tin compounds, in particular the Sn content, based on the element, in the polymer (P) is less than 30 ppm, most preferably Sn<5 ppm.

As a result of hydrolysis of the silane groups, the polymers (P) release carboxylic acids of structure R¹C(O)OH or R²C(O)OH. These can optionally also act as catalyst. The carboxylic acids of structure R¹C(O)OH or R²C(O)OH can remain in the crosslinked polymer (PX) or can be removed. Removal can take place for example by evaporation, optionally with heating, application of vacuum, or by washing out in or after the crosslinking step or a combination of these methods. Carboxylic acids of structure R¹C(O)OH or R²C(O)OH that have thirteen or fewer carbon atoms are preferably removed; R¹ or R² has in these cases twelve or fewer carbon atoms. Carboxylic acids of structure R¹C(O)OH or R²C(O)OH that have fourteen or more carbon atoms preferably remain in the crosslinked polymer (PX); R¹ or R² has in these cases thirteen or more carbon atoms. If carboxylic acids of structure R¹C(O)OH or R²C(O)OH are to be removed, the polymer (P) or (PX) can be left to age in water, wherein the carboxylic acids are dissolved out, emulsified or suspended by the water, depending on their water-solubility. An acid-trapping compound, for example ammonia or ammonium hydroxide, lime water, zinc oxide, aluminum hydroxide, potassium hydroxide or sodium hydroxide solution, potassium or sodium hydrogen carbonate or carbonate, can have been added or can be added to the water, so that the corresponding salts of the carboxylic acids form, which as a rule have better water-solubility than the acids themselves. The water used can be subcritical or supercritical. Instead of water, it is possible to use an aqueous solvent mixture, some other solvent or a solvent mixture. Preferably the crosslinking of the polymer (P) to the crosslinked polymer (PX) and the washing out of the hydrolysis products and optionally other undesirable components that can be washed out, which may originate from the polymer (P) or from additives, is carried out in one process step. The washing-out can also take place in a process step separate from the crosslinking or during the crosslinking a proportion of the hydrolysis products is dissolved out and the washing-out is continued on the crosslinked polymer (PX) or mixtures thereof.

Aging in water preferably takes place at at least 0° C., more preferably at least 5° C., most preferably at least 10° C., and preferably at most 180° C., more preferably at most 150° C., and most preferably at most 100° C. In an especially preferred embodiment the crosslinking takes place at ambient temperature, which depending on the environmental conditions is as a rule between −10° C. and 40° C., generally between 0° C. and 35° C.

Aging in water preferably takes place at pressures of at least 100 Pa, more preferably at least 1 kPa, most preferably at least 80 kPa, and preferably at most 10 MPa, more preferably at most 5 MPa, and most preferably at most 2 MPa. In an especially preferred embodiment the crosslinking takes place at ambient pressure, which depending on the environmental conditions is as a rule between 90 and 105 kPa.

The polymers (P) can be crosslinked very easily and at low cost. Articles of the crosslinked polymer (PX) of 1 mm thickness, without added catalyst, reach gel contents, measured according to DIN EN 579, of preferably >30%, more preferably >50%, and most preferably >65% after max. 7 days, preferably already after 24 hours of aging with access of humidity of the air to both sides at 23° C. and 50% relative humidity. If the crosslinked polymer is not in the geometric shape of a tube that is specified therein, then shavings complying with standard DIN EN 579 are prepared for testing and their gel content is determined according to the standard.

The polymers (P) or the corresponding crosslinked polymers (PX) can be used as such or in mixtures for the manufacture of solid or elongated moldings such as hoses, wire and cable insulation or sheathing or tubes, or for the production of binders, coatings, foams, fibers, mats or cloths. If a crosslinked polymer (PX) is to be used, the crosslinking described above preferably takes place partially or completely after forming, especially if forming takes place by the typical methods for processing thermoplastics, for example extrusion or injection molding. Forming can for example also take place by processing steps such as sawing, drilling, milling, punching, polishing, bending, cutting, pressing, stamping or grinding of the solid article; in these methods of forming, uncrosslinked polymer (P) can be processed and crosslinked later, or already crosslinked polymer (PX) can be processed.

Polymers (P1) can be produced according to the methods described above for production of the polymers (P), by selecting the silane of general formula I from the silanes of general formula II as component (B) in the grafting process or as component (E) in the copolymerization process. The possibilities for modification, for production of preparations or mixtures, for further treatment, for methods of crosslinking and for applications described for the polymers (P) or (PX) also apply to the polymers (P1). Crosslinking of polymers (P1) gives the corresponding crosslinked polymers (P1X).

All the above symbols of the above formulas have their meanings in each case independently of one another. Unless stated otherwise, the percentages given above are percentages by weight. In all the formulas, the silicon atom is tetravalent. Unless stated otherwise, all pressures stated represent absolute pressures. Unless stated otherwise, the definition “heteroatom” comprises all elements except carbon and hydrogen.

### EXAMPLES

### Production of Polymers (P)

Silane Grafting onto Polymers

### Peroxide

The peroxide used is characterized and designated as follows:

Peroxide A: 2,5-bis(tert-butylperoxy)-2,5-dimethyl-hexane (Luperox® 101 of the company Arkema)

Peroxide B: di-tert-butyl peroxide (DTBP, from Merck)

### Silane

The silane used is characterized and designated as follows:

Silane A: Vinylmethyldiacetoxysilane (“VMDAO” or “VMDAS”)
Structure: H₂C═CH—Si(Me)(OC(O)Me)₂
Produced according to the specification in Journal of the American Chemical Society, 1952, Vol. 74, p. 4584-4585, omitting the catalyst described there.

Silane B: Vinyltriacetoxysilane (“VTAO” or “UTAS”)
(GENIOSIL® GF 62 from Wacker Chemie AG)
Structure: H₂C═CH—Si(OC(O)Me)₃

Silane C: Vinyltrimethoxysilane (“VTMO” or “VTMS”)
(GENIOSIL® XL 10 from Wacker Chemie AG)
Structure: H₂C═CH—Si(OMe)₃

### Determination of Successful Grafting: Amount of Grafted Silane

The amounts of grafted silane were determined by measurement in inductively coupled plasma (“ICP”; element to be quantified: Si). The ICP-measured value (wt % Si) was converted to the concentration of grafted silane (wt % silane) by multiplying by the factor F=[M(silane)/28.0855 g/mol], where M(silane) is the relative molar mass of the grafted silane (silane A: 188.25 g/mol; silane B: 232.26 g/mol; silane C: 148.23 g/mol), and 28.0855 g/mol is the relative molar mass of the element silicon.

### Determination of Successful Grafting: Crosslinkable Fraction

The crosslinkable fraction of a sample was determined by storing a polymer sample (shavings) in water at 90° C. At time intervals of several hours, parts of the sample were taken and were extracted according to DIN EN 579 in stabilizer-containing xylene, to determine the gel content of the samples. After some period of aging in water—as a rule after 4 hours, at the latest after 24 hours—there was no longer any significant increase in gel content. This gel content was defined as the crosslinkable fraction of the polymer sample. The determinations of the crosslinkable fractions are examples of the crosslinking, according to the invention, of polymers (P) to polymers (PX) according to the invention.

### Determination of Water Content

The water content of polymers was determined by heating a sample of the polymer to 150° C. Gas released was transferred to a measuring cell, the amount of water was determined by Karl Fischer titration and was converted to the water content in the polymer sample used in ppm.

### Example 1

### Production of a Polymer (P) by Grafting of Vinylmethyldiacetoxysilane (Silane A) onto Highly Branched Polyethylene (According to the Invention)

Highly branched low-density polyethylene was used as grafting base. The polyethylene is, according to the manufacturer's data (as of April 2009), characterized by a melt flow index of 2250 g/10 min (2.16 kg/190° C.), a viscosity of 3550 mPa·s (190° C.), number-average molecular weight Mₙ=6900 g/mol and weight-average molecular weight M_{w}=23830 g/mol, a density of 906 kg/m³ and a softening point of approx. 102° C. (ring and ball). ¹H-NMR (solution in CCl₄ with addition of benzene-d6 as lock solvent, measurement temperature 60° C.) showed a degree of branching of 45 branchings per 1000 carbon atoms. It had a water content of <10 ppm (Karl Fischer), and is a product of Westlake Chemical Corporation with the trade name Epolene® C-10. 200 g of this polymer was inertized in glass apparatus with a reflux condenser with alternating vacuum and dry argon, and melted. At a melt temperature of 180° C., a mixture of silane A (12.7 g, 67.5 mmol) and peroxide A (0.4 g, 1.38 mmol) was added dropwise with mechanical stirring in the space of 30 minutes. The mixture was stirred for a further 20 minutes at 180° C., then the reflux condenser was replaced in an inert gas countercurrent with a distillation bridge and a dynamic vacuum was applied, which was slowly intensified to 0.6 mbar, while the internal temperature was still maintained at 180° C. Then the product (a polymer (P) according to the invention) was left to cool. A sample had a content of grafted silane A of 3.61% and a gel content of 3.5%, before contact with moisture. The crosslinkable fraction (gel content after aging in water at 90° C.; crosslinked polymer (PX)) was determined as 59%. This example shows that the production of practically uncrosslinked polymers (P) according to the invention is possible by deliberate exclusion of water, as also is their subsequent crosslinking to polymers (PX) in a separate downstream crosslinking step.

### Comparative Example 1

### Grafting of Vinyltriacetoxysilane (Silane B) onto Highly Branched Polyethylene (not According to the Invention)

Grafting was carried out as described in example 1, but replacing the silane with the corresponding amount of silane B (15.7 g). Before contact with moisture, a sample had a content of silane B of 5.97% and a gel content of 42.8%. The polymer obtained could not be formed by thermoplastic techniques to an article with a smooth surface. The crosslinkable fraction (gel content after aging in water at 90° C.; crosslinked polymer) was determined as 53%. Comparative example 1, not according to the invention, shows that (in contrast to example 1) even with exclusion of moisture, a partially crosslinked polymer is obtained, which therefore is not processable, or only with difficulty, by thermoplastic processes, when, as a departure from the method according to the invention, a vinyltriacyloxysilane (here: silane B in comparative example 1, not according to the invention) is used instead of a vinylmethyldiacyloxysilane of formula I (such as silane A in example 1 according to the invention). Comparison of the properties of the products from example 1 according to the invention with comparative example 1, not according to the invention, shows the surprising advantageous property of the vinylmethyldiacyloxysilanes versus the vinyltriacyloxysilanes for the production of uncrosslinked polymers (P) according to the invention, and of the polymers (P) themselves, as was presented above in the description of the invention.

### Example 2

### Use of Polymer (P) from Example 1 as Binder (Reactive Melt Adhesive) (According to the Invention)

Polymer (P) from example 1 was melted, filled in a cartridge and, using a melt adhesive gun (180° C.), without further admixtures, was used as a reactive hot melt adhesive. In each case two specimens with the dimensions 25 mm×100 mm×3 mm (wood (maple)) were glued on an overlap length of 12.5 mm, giving a single-shear lap joint with an area of 312.5 mm² (DIN EN 1465). The glued joints were cooled to room temperature within 5 minutes and during this time were pressed together, with loading with a 1 kg weight (approx. 9.8 N). The specimens were stored overnight at room temperature (approx. 20° C.) and atmospheric air humidity (approx. 40% relative air humidity). There was partial crosslinking to a polymer (PX). On the next day the specimens could only be broken apart with defibration of the wood. Tension shear measurements according to DIN EN 1465 showed tension shear strengths of about 5 MPa.

### Comparative Example 2

### Use of a Polymer not According to the Invention as Binder

The procedure as in example 2 was followed, but using the polymer Epolene® C-10, which was used as grafting base in example 1, in the ungrafted state. The resultant specimens could be broken apart with moderate application of force. Adhesive failure was observed in all cases; there was no instance of detachment of fibers from the wood. Tension shear measurements according to DIN EN 1465 showed tension shear strengths of about 1 MPa.

Comparative example 2, not according to the invention, shows in comparison with example 2 according to the invention that the silane groups in the polymers according to the invention lead to a decisive improvement in adhesion of the binder. The cohesion is further improved by the crosslinking.

### Example 3

### Use of Polymer (P) from Example 1 for Producing a Coating (According to the Invention)

A few grams of the polymer (P) from example 1 were melted in an aluminum dish at 140° C. in a drying cabinet. After cooling, it was not possible to detach the coating from the aluminum, without destroying the aluminum dish. The polymer (P) was crosslinked by the action of the humidity of the air to a polymer (PX), which was demonstrated by the fact that the coating could not be melted again by heating to 140° C.

### Comparative Example 3

### Use of a Polymer not According to the Invention as Binder for Producing a Coating

The procedure as in example 3 was followed, but using the polymer Epolene® C-10, which was used as grafting base in example 1, in the ungrafted state. The resultant coating could easily be detached again from the aluminum dish, and could be melted repeatedly at 140° C.

Comparative example 3, not according to the invention, shows in comparison to example 3 according to the invention, that the silane groups in the polymers according to the invention decisively improve the adhesion of the binder. The cohesion and the heat resistance or thermal stability are further improved by the crosslinking.

### Comparative Example 4

### Attempt to Use a Polymer not According to the Invention as Binder for Making Coatings and Glued Joints

The product from comparative example 1 (not according to the invention) was used, and the procedure as in comparative example 2, not according to the invention, or comparative example 3, not according to the invention, was followed. The desired specimens could not be produced in any instance, as the gel-containing, precrosslinked product from comparative example 1, not according to the invention, could not be melted, and therefore neither the production of glued joints nor of coatings was possible.

### Example 4

### Production of a Polymer (P) by Grafting Silane onto Polyethylene in the Laboratory Extruder; Controlled Partial Crosslinking to Crosslinked Polymer (PX) by Controlled Water Content

The grafting reaction was carried out in a co-rotating twin-screw extruder (ZE 25, from Berstorff) at an L/D ratio of 47 and a screw diameter of 25 mm. The extruder was operated with the following parameters: temperature profile (in ° C.): 130/130/150/190/210/215/215/210/210 (head temperature); discharge approx. 10 kg/h; rotary speed 200 rev/min.

The medium-density polyethylene (MDPE) used is characterized by a melt flow index of 3.5 g/10 min (2.16 kg/190° C.), a density of 944 kg/m³ and a VICAT softening point of approx. 123° C. It had a water content of 62 ppm (Karl Fischer). Peroxide B described above (di-tert-butyl peroxide, DTBP, from Merck) and silanes A, B or C described above were used for the tests. Silane and peroxide were mixed and were metered into the third heating zone at 150° C. using a metering pump from the company Viscotec into the polymer melt. Volatile matter was removed from the melt in the last zone before the extruder head at a vacuum of 200-300 mbar (absolute pressure). The graft polymers obtained were formed by a perforated die to a round section, cooled in an air cooling section with dry compressed air and granulated. Samples both of the round section and of the granules were stored under nitrogen with exclusion of moisture. The perforated die serves as one example; dies which, for example, make the production of hoses, tubes, wire insulation or cable sheathing possible, can be used similarly.

The silane graftings carried out are summarized in Table 1 below. The amount of silane in the grafted products was calculated from ICP-OES measured values as described above.

TABLE 1
Silane graftings carried out (parts by weight)

| Example No. | 4a | 4b*** | 4c*** |
|---|---|---|---|
| MDPE | 100 | 100 | 100 |
| DTBP | 0.10 | 0.10 | 0.10 |
| Silane A | 1.27* | | |
| Silane B | | 1.57* | |
| Silane C | | | 2.0** |
| Wt % Si in the grafted | 0.09 | 0.18**** | 0.30 |
| product (ICP-OES) | | | |
| Wt % of the respective | 0.60 | 1.49**** | 1.58 |
| silane in the grafted | | | |
| product | | | |
| Gel content of the | 57% | 71% | 0% |
| grafted product | | | |

*Corresponds to 67.5 mmol silane per kg MDPE.
**Corresponds to 135 mmol silane per kg MDPE.
***Not according to the invention.
****Vinyltriacetoxysilane already crosslinked purely thermally in reactive extrusion. Crosslinked silane is not removed during removal of volatile matter, whether or not it is bound to the polymer. Measurement of the silicon content and its conversion to the amount of corresponding silane used is therefore not a measure for the grafting yield in this case.

The grafted product from example 4a (according to the invention) had a smooth surface. The grafted product from example 4b (not according to the invention) had transverse grooves and bumps with a height difference of approx. 1 mm. Example 4a shows, in comparison with example 4b, that the polymers according to the invention, which have units that are derived from the monomer vinylmethyldiacyloxysilane of formula I, can be processed by usual methods to products with usable surface structure (example 4a), whereas polymers that have units that are derived from a vinyltriacyloxysilane monomer cannot be processed successfully by forming operations (example 4b). The test specimens from example 4c also had a smooth surface, but, as the following examples show, could only be crosslinked under harsh conditions or with catalyst.

### Example 5

### Crosslinking Characteristics and Production of a Polymer (PX)

The strand-shaped grafted products according to example 4a-c were cut into samples each with a length of approx. 5 cm. In each case samples were stored in each case for 10 minutes, 30 minutes, 1 hour and 4 hours in a water bath at 20° C. or at 90° C. Further samples were stored in normal climate (23° C./50% relative humidity) for 1 hour, 4 hours and 24 hours.

After storage in water, the test specimens were dried mechanically. Then, for measurement of crosslinking at the test specimen surface, shavings with a thickness of 0.2 mm were planed from the test specimens using a lathe, removing an outer layer totalling approx. 0.4-0.6 mm. To measure the crosslinking over the entire test specimen cross section, a piece with a length of 1 cm was cut off from the start and end of the test specimen and discarded, and cross sections of approx. 0.2 mm thickness were cut from the remaining 3 cm of the test specimens on the freshly cut surfaces. The shavings and the cross sections were extracted according to DIN EN 579 in boiling xylene for 8 h. The gel content was determined from the weight difference of the sample before and after extraction and drying, and is given as a percentage of the weight of the sample used for the determination. For comparison, corresponding samples were obtained from dry strand samples before aging in water, immediately after production by reactive extrusion. The results are summarized in the following Table 2 (cells without data mean that the corresponding values were not determined).

Example 5a shows that the polymers according to the invention not only can be processed in the forming process, but they then reach, without added catalyst and in mild conditions (i.e. storage in water at 20° C. or aging at 23° C. and 50% relative humidity of the air) after a few hours, the same degree of crosslinking, measured from the gel content, as corresponding samples that were crosslinked under harsh conditions (aging in water at 90° C.). In addition, the polymers according to the invention crosslink rapidly through to the depth, as shown by comparison of the gel content measurements of the sample cross sections with the sample surfaces. For example, water that can be dissolved, for example in the polymer, even before processing, can serve for deep crosslinking. Surprisingly, the vinylmethyldiacyloxysilanes display a reactivity that is so high that incorporation of the units derived from this monomer in a polymer and efficient crosslinking are possible, however it is still not so high that it impairs good forming in the presence of any traces of water optionally present. Example 5a shows three embodiments for the production of examples (PX) according to the invention (various aging/crosslinking conditions). The fact that the gel content increases during aging relative to the sample measured before aging shows that for the method of production described in example 4a, a partially crosslinked, but not completely crosslinked polymer was produced.

Example 5b shows that even polymers that contain units that were derived, instead of from vinylmethyldiacyloxysilanes as monomer, from the corresponding vinyltriacyloxysilanes as monomer, are also fully crosslinked rapidly and well, but the polymers based on vinyltriacyloxysilanes are too reactive for the forming process, as is clear from the high gel content after aging (71%) and from the uneven surface structure of the grafted product, i.e. from the deficient forming (see example 4b). Moreover, the vinyltriacyloxysilane, as is shown below in comparative example 7, can already form siloxanes before grafting, which is promoted by the increased temperature, so that in the course of grafting of these siloxanes, a crosslinked polymer is formed directly.

TABLE 2
Crosslinking. Extraction according to DIN EN 579.

| | Test speci- | | Surface | Gel content according to aging time | | | | | | |
|---|---|---|---|---|---|---|---|---|---|---|
| Ex. | men from | | (SF) or cross | before | 10 | 30 | | | | |
| No. | Ex. No. | Aging at | section (CS) | aging | min | min | 1 h | 4 h | 24 h | 168 h |
| 5a | 4a | 20° C. | SF | 57% | 58% | 61% | 59% | 77% | 76% | 78% |
| | | water | CS | | 62% | 72% | 71% | 74% | 73% | 78% |
| | | 90° C. | SF | | 59% | 65% | 71% | 78% | 77% | 79% |
| | | water | CS | | 59% | 65% | 71% | 78% | 77% | 79% |
| | | 23° C. | SF | | | | 74% | | 72% | 80% |
| | | 50% RH | CS | | | | 77% | 77% | 77% | 77% |
| 5b *** | 4b *** | 20° C. | SF | 71% | 78% | 78% | 79% | 80% | 77% | 83% |
| | | water | CS | | | | | | | 86% |
| | | 90° C. | SF | | 80% | 79% | 81% | 77% | | |
| | | water | | | | | | | | |
| | | 23° C. | SF | | | | | 88% | 85% | |
| | | 50% RH | | | | | | | | |
| 5c *** | 4c *** | 90° C. | SF | 0% | | | | | 23% | |
| | | water | | | | | | | | |

*** not according to the invention.

Example 5c shows that polymers in which the acyloxysilane was replaced with an alkoxysilane (here: vinyltrimethoxysilane) are much too unreactive for catalyst-free crosslinking, even when harsh conditions (aging in water at 90° C.), increased silane loading and crosslinking at the surface (where water access is better than over the whole cross section of the test specimen) are considered. This can be demonstrated by the measured value of gel content after aging for 24 hours in hot water at 90° C., which is only 23% on the surface of the vinyltrimethoxysilane-based polymer.

The crosslinking kinetics of comparable alkoxysilane-based polymers (silane loading 1.0 or 2.0 parts by weight vinyltrimethoxysilane per 100 parts by weight MDPE, corresponding to 67.5 or 135 mmol silane per kg MDPE) with catalysis by dibutyltin dilaurate was described in WO 2009 033 908 A2 for graft polymers based on the same MDPE as grafting base. Even with catalyst added, after a crosslinking time of 4 or 24 hours, for the vinyltrimethoxysilane loading of 67.5 mmol per kg MDPE, only 40% or 59% gel content is achieved, respectively, and for the vinyltrimethoxysilane loading of 135 mmol per kg MDPE, only 59% or 69% (see the examples, designated as example 12b and 12c, in WO 2009 033 908 A2). This shows that the polymers according to the invention that have units derived from vinylmethyldiacyloxysilane of formula I as monomer, even without added catalyst and even with smaller amount of silane used (both in relation to the amount of substance used and the mass of silane used) crosslink far better than corresponding polymers not according to the invention, which instead have vinylalkoxysilanes as monomers at higher loading and are crosslinked with catalyst.

### Example 6

### Washout of the Carboxylic Acid Released by Hydrolysis from a Polymer (P)

The polymer strand from example 4a was comminuted in a granulator to granules with grain length of 2 mm perpendicular to the principal axis of the strand. Hot water at 90° C. (69.8 g) was added to the granules (23.3 g) and the mixture was heated at 90° C. At defined time intervals, samples were taken of the water used for aging and the acetic acid content of the water used for aging was determined in each case. The difference in acetic acid content from the preceding time interval in each case was calculated and was used for calculating the amount of acetic acid released [μg] per gram of polymer and per hour of aging time.

| | amount of acetic acid |
|---|---|
| | released in the interval [μg |
| Aging interval | AcOH/(g polymer × h)] |
| 0-1 h | 1233 |
| 1-2 h | 1017 |
| 2-3 h | 509 |
| 3-4 h | 320 |
| 4-5 h | 291 |
| 5-24 h | 120 |
| 24-70 h | 5 |
| 70-91 h | 2 |
| 91-164 h | 0 |

The data show that release of acetic acid has stopped almost completely after 24 hours. A similar comparative experiment, in which sodium hydroxide solution (c(NAOH)=0.1 mol/l) was used as the aging medium, gave the same result. A similar comparative experiment, in which water was used as the aging medium, but the water was completely replaced after each time interval, also gave the same result. Removal of the acetic acid thus takes place very simply by aging in stagnant water.

### Example 7

### Production of Vinylmethyldistearoyloxysilane (Silane According to the Invention of Formula II)

The procedure was similar to the specification described in section [0101] of US 2004/0228902 A1 (designated there as “Example 19”), using, instead of the batch sizes described there, vinylmethyldichlorosilane (36.2 g, 256.6 mmol), triethylamine (52.0 g, 513.9 mmol) and anhydrous tetrahydrofuran (1 L), and stearic acid (146.0 g, 513.2 mmol) instead of the ibuprofen described there. After reaction under reflux and cooling, it was filtered, the filter cake was washed with tetrahydrofuran (500 mL), the filtrate and the wash solution were combined, concentrated by vacuum evaporation and the residue was dried (150° C., 1 mbar). An oil remained (160 g), which could not be evaporated in the selected conditions, which on cooling to room temperature solidified to a colorless solid. It was vinylmethyldistearoyloxysilane. The solid was recrystallized twice, each time from 240 mL of boiling n-heptane by cooling the solution to room temperature, and after each recrystallization it was washed with n-heptane (each time 120 mL). The residue was dried under vacuum. The product vinylmethyldistearoyloxysilane (139 g, yield 85% of theory) was obtained as a colorless crystalline solid, melting point 54-55° C. ¹H-NMR (500.1 MHz C₆D₆) δ=0.76 ppm (s, 3H, SiCH₃), 1.02 ppm (t, ³J_{HH}=6.9 Hz, 6H, C(O)(CH₂)₁₆CH₃), 1.21-1.52 ppm (m, 56H, C(O)CH₂CH₂(CH₂)₁₄CH₃), 1.57-1.72 ppm (m, 4H, C(O)CH₂CH₂), 2.29 ppm (t, ³J_{HH}=7.4 Hz, 4H, C(O)CH₂), 6.12 ppm (δ_{A}), 6.13 ppm (δ_{b}), 6.43 ppm (δₓ), |²J_{AB}|=3.2 Hz, ³J_{AX}=14.8 Hz, ³J_{BX}=20.8 Hz. ²⁹Si—NMR (99.4 MHz, C₆D₆) −13.2 ppm.

### Example 8

### Production of a Polymer (P1) by Grafting of Vinylmethyldistearoyloxysilane (Product from Example 7) on Polyethylene (According to the Invention)

Highly branched low-density polyethylene was used as grafting base. According to the manufacturer's data, the polyethylene is characterized by a melt flow index of 150 g/10 min (2.16 kg/190° C.), a density of 913 kg/m³ and a softening point of 72° C. (Vicat/ISO 306). It is a product of the company ExxonMobil with the trade name LDPE LD 655. ¹H-NMR (see example 1 for measurement technique) showed a degree of branching of 38 branchings per 1000 carbon atoms. It had the following temperature-dependent dynamic melt viscosity: 125° C., 302.6 Pa·s; 150° C., 158.6 Pa·s; 170° C., 112.5 Pa·s, 190° C., 68.2 Pa·s. Using gel permeation chromatography, the number-average molecular weight of the polymer Mn was determined as 16.6 kg/mol and the weight-average molecular weight Mw as 165 kg/mol. It had a water content of 15 ppm (Karl Fischer).

225 g of this polymer was inertized in glass apparatus (protective gas: argon). Under protective gas, 38.6 g (60.6 mmol) of the product from example 7 and 230 mg (792 μmol) of Peroxide A were added. The mixture was heated in an oil bath, increasing the oil bath temperature to 190° C. within 45 minutes. When the internal temperature reached approx. 130° C., a mechanical stirrer was switched on. After the oil bath reached 190° C., it was held at this temperature for a further 20 minutes, then a vacuum of 0.6 mbar was applied for 90 minutes, at the same temperature. The product had the following temperature-dependent dynamic melt viscosity: 125° C., 409.7 Pa·s; 150° C., 255 Pa·s.

Then the product (a polymer (P1) according to the invention) was left to cool. A sample had a gel content of 6.8% before contact with moisture. The crosslinkable fraction (gel content after aging in water at 90° C.; crosslinked polymer (P1X)) was found to be 58%.

### Example 9

### Use of Polymer (P1) from Example 8 as Binder (Reactive Melt Adhesive) (According to the Invention)

The polymer (P1) from example 8 was melted, filled in a cartridge and, without further admixtures, was used as a reactive hot melt adhesive, using a melt adhesive gun (180° C.). In each case two specimens with the dimensions 25 mm×100 mm×3 mm (wood (maple)) were glued on an overlap length of 12.5 mm, so that a single-shear lap joint with an area of 312.5 mm² was produced (DIN EN 1465). In further series, in each case two specimens with the dimensions 25 mm×50 mm×3 mm or 12.5 mm×50 mm×3 mm (wood (maple)) were glued on an overlap length of 16 mm, so that a single-shear lap joint with an area of 400 mm² or of 200 mm² was produced. All the glued joints were cooled to room temperature within 5 minutes and during this time they were pressed together with loading with a weight of 1 kg (approx. 9.8 N). All the specimens were aged in normal climate according to DIN EN ISO 291 (23° C., 50% relative humidity, maximum deviation of class 1 for temperature and relative humidity) at atmospheric air pressure (access of air to both sides of the test specimen). Crosslinking to a polymer (P1X) took place. Odor of the polymer (P1), or of the carboxylic acid cleavage product, was not perceptible during hot processing or during aging. Tension shear measurements according to DIN EN 1465 (specimens with 312.5 mm² overlap area) showed the following tension shear strengths (measurement at 20° C., mean values from 5 individual measurements in each case (±standard deviation)):

Before aging (on the day of production of the glued joint):
4.17 MPa (±0.45 MPa)

After aging for 1 day: 4.40 MPa (±0.57 MPa)

After aging for 7 days: 4.48 MPa (±0.83 MPa).

All specimens broke with adhesive failure.

For measurement of thermal stability, specimens with 200 mm² and with 400 mm² overlap area were hung in a heating cabinet and were loaded with a tensile force of 20 N by applying a 2.04 kg weight; this corresponds to a tension shear stress of 0.10 MPa (20 N/200 mm²) or of 0.05 MPa (20 N/400 mm²) along the principal axis of the specimens. The heating cabinet was heated at a heating rate of 5° C./minute. The specimens fractured at the following temperatures (mean values from 3 measurements in each case):

Before aging (on the day of production of the glued joint):
0.10 MPa, 117° C.; 0.05 MPa, 137° C.

After aging for 1 day:
0.10 MPa, 120° C.; 0.05 MPa, 175° C.

After aging for 7 days:
0.10 MPa, 117° C.; 0.05 MPa, 180° C.

### Comparative Example 5

### Use of a Polymer not According to the Invention as Binder (Melt Adhesive)

The polymer used in example 8 as grafting base (ExxonMobil LDPE LD 655) was used in unmodified form and a procedure was followed similar to that described in example 9.

Tension shear measurement according to DIN EN 1465 (specimens with 312.5 mm² overlap area) gave the following measured values:

Before aging (on the day of production): 2.11 MPa (±0.20 MPa)

After aging for 1 day: 1.76 MPa (±0.06 MPa)

After aging for 7 days: 1.75 MPa (±0.11 MPa)

After aging for 14 days: 2.06 MPa (±0.36 MPa)

All specimens broke under adhesive failure.

The thermal stability measurements gave the following measured values (procedure as described in example 9):

Before aging (on the day of production):
0.10 MPa, 107° C.; 0.05 MPa, 119° C.

After aging for 1 day:
0.10 MPa, 91° C.; 0.05 MPa, 105° C.

After aging for 7 days:
0.10 MPa, 91° C.; 0.05 MPa, 107° C.

This comparative example shows, as a direct comparison with the same test with the corresponding grafted material (see example 9), that the polymer (P1) according to the invention, which contains units derived from the monomers ethylene and a vinylmethyldiacyloxysilane of general formula II (see example 8), with respect to adhesion and thermal stability, is far more suitable as binder (see example 9) than the unmodified polymer not according to the invention, which only has units derived from the monomer ethylene (this comparative example).

### Example 10

### Crosslinking of Polymer (P1) from Example 8 Under Mild Conditions (23° C., 50% Relative Humidity) to Polymers (P1X) (According to the Invention). Effect on Gel Content and Cohesion (Maximum Tensile Stress)

The polymer (P1) from example 8 was melted without further admixtures and then pressed at 135° C. to a 1 mm (±0.2 mm) thick plate, and cooled. Rectangular test specimens were prepared with the dimensions 15 mm×10 mm×1.0 mm (±0.2 mm) and test specimens were stamped out with the punch according to DIN 53504/Type S2 and stored at atmospheric air pressure in normal climate according to DIN EN ISO 291 (23° C., 50% relative humidity, maximum deviation of class 1 for temperature and relative humidity) (access of air to both sides of the test specimens).

Individual test specimens with the dimensions 15 mm×10 mm×1.0 mm (±0.2 mm) were, after defined aging times, packed in special-steel nets of known mass (mₙ) (closure by edge folding), weighed (m₁) and extracted for 4 hours in boiling para-xylene, to which 2,2′-methylene bis(6-tert-butyl-4-methylphenol) had been added (1%). The weight ratio of para-xylene to sample was 500 parts:1 part. The samples were taken while hot, washed with xylene, dried for 1 hour at room temperature in the air and for a further 1 hour at 140° C. and weighed again (m₂). The gel content is the fraction of the sample that is insoluble in boiling xylene, which is calculated from

Gel content=1−[(m₁−m₂)/(m₁−mₙ)]

The gel content is given hereunder as a percentage [%].

As a function of the aging time in standard climate, the following gel contents were measured (mean values from 2 measurements in each case):

After aging for 1 day: 22%

After aging for 7 days: 54%

The example shows that polymers (P1) according to the invention, when aged under mild conditions (23° C., 50% relative humidity), crosslink promptly, reaching almost the same gel content as the maximum gel content that is determined under harsh conditions (storage in water at 90° C., see example 8), which means that polymers (P1) crosslink quickly and practically completely under mild conditions.

The test specimens that had been stamped out with the punch according to DIN 53504/Type S2, were submitted, after defined aging times, to tensile testing according to DIN EN ISO 527-1 (pulling speed 50 mm/min).

As a function of the aging time under standard climate, the following maximum tensile stresses and elongations at break were measured (mean values from 4 measurements in each case±standard deviation):

Immediately after production of the specimens (no aging):
Maximum tensile stress: 6.50 MPa (±0.08 MPa)
Elongation at break: 226% (±42 percentage points)

After aging for 1 day:
Maximum tensile stress: 7.28 MPa (±0.47 MPa)
Elongation at break: 225% (±68 percentage points)

After aging for 7 days:
Maximum tensile stress: 8.12 MPa (±0.29 MPa)
Elongation at break: 199% (±73 percentage points)

### Comparative Example 6

### Effect of Aging Under the Action of Moisture on Gel Content and Cohesion of a Polymer not According to the Invention

The polymer used in example 8 as grafting base (ExxonMobil LDPE LD 655) was used in unmodified form and the procedure followed was similar to that described in example 10.

The polymer did not develop a gel content at any time point.

The test specimens, which had been stamped out with the punch according to DIN 53504/Type S2, were submitted, after defined aging times, to tensile testing according to DIN EN ISO 527-1 (pulling speed 50 mm/min).

As a function of the aging time under standard climate, the following maximum tensile stresses and elongations at break were measured (mean values from 4 measurements in each case±standard deviation):

Immediately after preparation of the specimens (no aging):
Maximum tensile stress: 6.81 MPa (±0.10 MPa)
Elongation at break: 118% (±38 percentage points)

After aging for 1 day:
Maximum tensile stress: 6.96 MPa (±0.26 MPa)
Elongation at break: 102% (±34 percentage points)

After aging for 7 days:
Maximum tensile stress: 7.22 MPa (±0.39 MPa)
Elongation at break: 64% (±4 percentage points)

This comparative example shows, in direct comparison with the same test with the corresponding grafted material (see example 10), that the polymer (P1) according to the invention, which contains units derived from the monomers ethylene and a vinylmethyldiacyloxysilane of formula II (see example 8), with respect to toughness is much more suitable as binder (see example 10) than the unmodified polymer, not according to the invention, which only has ethylene as monomer, which can be established from the lower elongation at break and maximum tensile stress of the polymer not according to the invention, in this comparative example.

### Comparative Example 7

### Thermal Loading Capacity of Di- and Triacyloxysilanes Bearing Vinyl Groups and/or Saturated Alkyl Groups

A model experiment demonstrated the surprising difference in the themal loading capacity of di- and triacyloxysilanes. Vinyltriacetoxysilane was selected as a typical representative of vinyltriacyloxysilanes, from which polymers not according to the invention (for example containing, as monomers, units derived from ethylene and vinyltriacyloxysilanes) can be produced, and vinylmethyldiacetoxysilane was selected as a typical representative of vinylmethyldiacyloxysilanes, from which polymers (P) according to the invention (containing units that are derived from the monomers ethylene and vinylmethyldiacyloxysilane) can be produced. In grafting or copolymerization reactions of said silanes, the vinyl groups react to saturated groups, therefore ethyltriacetoxysilane (model substance for polymers not according to the invention, containing units derived from vinyltriacyloxysilanes as monomer) and dimethyldiacetoxysilane (model substance for polymers (P) according to the invention containing units derived from the monomers ethylene and vinylmethyldiacyloxysilane) were used as model substances for the corresponding polymers. The corresponding silanes were dissolved at a concentration of 200 mmol per kg solvent in dry n-tetradecane. n-Hexadecane (2 wt %) was added as inert quantitative internal standard. A sample was taken from the mixture and the amount of silane relative to the internal standard was determined. Then the mixture was heated under inert conditions (protective gas: dry argon) to 215° C., which corresponds to a typical processing temperature for corresponding polymers derived from the vinylsilanes used, and the amount of silane remaining was checked at regular intervals for at least 30 minutes (normalization based on the internal standard; attainment of 200° C. internal temperature was defined as the starting time point t=0). The results are presented in Table 3.

TABLE 3
Results of the model experiments for comparing the
thermal stability of di- and triacyloxysilanes.

| Entry No. | Silane | Result |
|---|---|---|
| 1 | Vinylmethyldiacetoxysilane | no reaction (>30 min) |
| 2 | Dimethyldiacetoxysilane | no reaction (>30 min) |
| 3 | Vinyltriacetoxysilane | decomposition (<3 min) |
| 4 | Ethyltriacetoxysilane | decomposition (<3 min) |

For triacyloxysilanes (entries 3 and 4), complete decomposition was observed within less than 3 minutes. Acetic acid anhydride was detected as a decomposition product (analysis by gas chromatography). The decomposition reaction of the vinyl- or alkyltriacyloxysilanes is in each case siloxane formation with cleavage of the corresponding carboxylic acid anhydride. Under the selected conditions, the tendency to decompose is independent of whether the silane has a vinyl group (entry 3) or not (entry 4). This means, for processes for attaching triacyloxysilane groups to polymers, that neither the vinyltriacyloxysilanes used (model: entry 3) nor the resultant polymers (model: entry 4) are manageable.

In contrast, the corresponding vinylmethyldiacyloxysilanes, in which an acyloxy group was replaced with a methyl group (correspondence: entry 1 versus 3 and entry 2 versus 4), are thermally stable under inert conditions. This minimal structural change thus has the surprising effect that vinylmethyldiacyloxysilanes can be used for the production of polymers that have units derived from vinylmethyldiacyloxysilanes as monomer (entry 1) and that the corresponding polymers are thermally stable (entry 2).

1.-12. (canceled)

13. Polymers comprise polymerized units derived from ethylene and at least one vinylmethyldiacyloxysilane of formula I 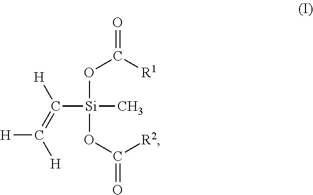
wherein R¹ and R² are independently hydrogen or hydrocarbon residues.

14. The polymers of claim 13, wherein the vinylmethyldiacyloxysilane of formula I is a vinylmethyldiacyloxysilane of formula II, 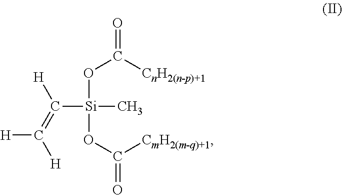
wherein
m and n each independently is an integer greater than or equal to 4,
p is an integer from 0 to n and
q is an integer from 0 to m.

15. The polymers of claim 14, wherein, in the vinylmethyldiacyloxysilane of formula II, m and n are independently of one another integers from 13 to 40.

16. The polymers of claim 14, wherein, in the vinylmethyldiacyloxysilane of formula II, m and n are independently integers from 4 to 40, and the residues CₙH₂₍ₙ₋ₚ₎₊₁ and CₘH_{2(m-q)+1} are acyclic hydrocarbon residues.

17. Vinylmethyldiacyloxysilanes of formula II, 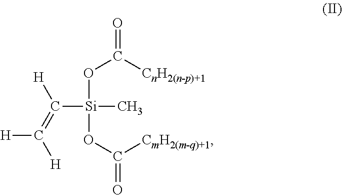
in which
m and n are independently integers from 13 to 40,
p is an integer from 0 to n and
q is an integer from 0 to m.

18. Vinylmethyldiacyloxysilanes of formula II, 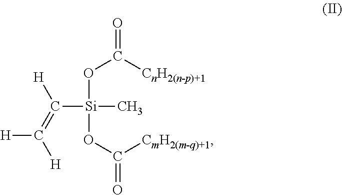
in which
m and n are integers from integral values from 4 to 40,
p is an integer from 0 to n,
q is an integer from 0 to m, and the residues C₁H₂₍ₙ₋ₚ₎₊₁ and CₘH_{2(m-q)+1} are acyclic hydrocarbon residues.

19. A method of producing a polymer of claim 13 comprising radical grafting a mixture comprising
(A) a polymer, which contains units that are derived from the monomer ethylene (grafting base),
(B) a silane of formula I, and
(C) a radical initiator which releases radicals which facilitate grafting of (B) onto (A).

20. A method of producing a polymer of claim 13 by radical copolymerization, comprising copolymerizing mixture comprising
(D) ethylene,
(E) a silane of formula I, in the presence of
(F) a radical initiator which releases radicals which facilitate copolymerization of (D) and (E).

21. A method of crosslinking a polymer of claim 13 with water, comprising exposing the polymer to water, producing a crosslinked polymer.

22. A crosslinked polymer produced by the method of claim 21.

23. A molding, hose, tube, cable sheathing, cable insulation, binder, coating, foam, fiber, mat or cloth comprising a polymer of claim 13.

24. A molding, hose, tube, cable sheathing, cable insulation, binder, coating, foam, fiber, mat or cloth, comprising a crosslinked polymer of claim 13.
